(19) United States
(12) Patent Application Publication
(10) Pub. No.: US 2006/0080784 A1
(43) Pub. Date: Apr. 20, 2006

(54) Isocyanate-based tanning agents

(76) Inventors: Michael Ebbinghaus, Leverkusen (DE); Franz Heinzelmann, Leverkusen (DE); Martin Kleban, Leverkusen (DE); Jurgen Reiners, Leverkusen (DE)

Correspondence Address: LANXESS CORPORATION, 111 RIDC PARK WEST DRIVE, PITTSBURGH, PA, 15275-1112, US

(21) Appl. No.: 11/238,416

(22) Filed: Sep. 29, 2005

(30) Foreign Application Priority Data
Oct. 15, 2004 (DE) 1020040502846

(51) Int. Cl. C14C 3/08

(52) U.S. Cl. 8/94.33

(57) ABSTRACT

Aqueous composition containing a) at least one compound containing carbamoylsulphonate groups and b) at least one alcohol alkoxylate.

The invention relates to aqueous compositions containing at least one compound containing carbamoylsulphonate groups and at least one alcohol alkoxylate, processes for the preparation thereof and their use as a tanning agent or pretanning agent.

Isocyanates and their use as tanning agents are known in principle and are described, for example, in U.S. Pat. No. 2,923,594 “method of tanning”, U.S. Pat. No. 4,413,997 “dicarbamoylsulphonate tanning agent” or H. Träiubel, Tanning in Isocyanaten [Isocyanates], 1st and 2nd parts, Das Leder [Leather], 1977, pages 150 et seq. and 181 et seq.

It has been found that only isocyanates having a relatively low molecular weight are capable of effectively crosslinking the collagen molecules and hence increasing the shrinkage temperature of the leather.

However, owing to their toxicological properties, the high vapour pressure and the low water solubility, these compounds cannot be used in commercial tanning machines. Moreover, isocyanates in aqueous solution react rapidly via the intermediates carbamoyl acid and amine to give polymeric urea which has no tanning action at all. Temporary blocking of the isocyanate functionality with a protective group is therefore advisable.

EP-A 0 690 135 and EP-A 0 814 168 describe modified isocyanates by means of which these problems can be limited. For this purpose, selected isocyanates are first reacted with a polyetheralcohol, and then converted with bisulphite into the carbamoyl compound, which is substantially inert to the reaction with water. An aqueous dispersion having a stability sufficient for use in the tanning process is obtained. However, this process has two serious disadvantages:
The reaction of isocyanate with polyether alcohol must be carried out in the absence of water and preferably without a viscosity-depressing solvent and therefore requires technically high quality and expensive hardware.
By coupling the alcohol to the isocyanate, a part of the isocyanate functions is consumed and hence the tanning action of the product is reduced.

Isocyanate-based products which do not have these disadvantages have now been found.

The invention therefore relates to an aqueous composition containing
a) at least one compound containing carbamoylsulphonate groups and
b) at least one alcohol alkoxylate.

The compositions according to the invention preferably contain—calculated as sodium salt and based on solids—51 to 99, preferably 61 to 97, % by weight of compounds containing carbamoylsulphonate groups. Suitable compounds of component a) which contain carbamoylsulphonate groups are preferably reaction products of organic isocyanates and bisulphites and/or disulphites.

Suitable organic polyisocyanates are aliphatic, cycloaliphatic, araliphatic, aromatic or heterocyclic polyisocyanates, as described, for example, by W. Siefken in Liebigs Annalen der Chemie 562, pages 75 to 136.

The organic isocyanate having a functionality of 1.8 to 3.5 and preferably a molecular weight of <800 g/mol is preferred, in particular an isocyanate having a functionality of 2 and a molecular weight of <400 g/mol.

Preferred polyisocyanates are compounds of the formula Q(NCO)ₙ having an average molecular weight below 800, in which n denotes a number of at least 2, preferably of 2 to 4, and Q denotes an aliphatic C₄-C₁₂-hydrocarbon radical, a cycloaliphatic C₆-C₁₅-hydrocarbon radical or a heterocyclic C₂-C₁₂ radical having 1 to 3 hetero atoms from the series consisting of oxygen, sulphur and nitrogen, for example (i) diisocyanates, such as ethylene diisocyanate, 1,4-tetramethylene diisocyanate, 1,6-hexanethylene diisocyanate, 1,12-dodecane diisocyanate, 2-isocyanatomethyl-1,8-octamethylene diisocyanate, cyclobutane 1,3-diisocyanate, cyclohexane 1,3- and 1,4-diisocyanate and any desired mixtures of these isomers, 1-isocyanato-2-isocyanatomethylcyclopentane, 1-isocyanato-3,3,5-trimethyl-5-isocyanatomethylcyclohexane, 2,4- and 2,6-hexahydrotoluylene diisocyanate and any desired mixtures of these isomers, hexahydro-1,3- and/or -1,4-phenylene diisocyanate, perhydro-2,4′- and/or -4,4-diphenylmethyl diisocyanate, 1,3- and 1,4-phenylene diisocyanate, 2,4- and 2,6-toluylene diisocyanate and any desired mixtures of these isomers, diphenylmethane-2,4′- and/or -4,4′-diisocyanate, naphthalene 1,5-diisocyanate, polyisocyanates containing uretdione groups, such as, for example, bis(6-isocyanatohexyl)uretdione or the dimers of 1-isocyanato-3,3,5-trimethyl-5-isocyanatomethylcyclohexane which contain the uretdione structure, and any desired mixtures of the abovementioned polyisocyanates; (ii) trifunctional polyisocyanates and polyisocyanates having a higher functionality, such as the isomers of the triisocyanatotriphenylmethane series (such as triphenylmethane 4,4′,4′-trisocyanate) and their mixtures; (iii) compounds prepared from the polyisocyanates (i) and/or (ii) by allophanatization, trimerization or biuretization, which compounds have at least 3 isocyanate groups per molecule. Examples of polyisocyanates prepared by trimerization are that trimer of 1-isocyanato-3,3,5-trimethyl-5-isocyanatomethylcyclohexane which is obtainable by isocyanurate formation and the polyisocyanates which are obtainable by trimerization of hexamethylene diisocyanate, optionally as a mixture with 2,4′-diiso-cyanatotoluene, and containing isocyanurate groups. Examples of polyisocyanates prepared by biuretization are tris(isocyanatohexyl)biuret and mixtures thereof with its higher homologues, as are obtainable, for example, according to German Offenlegungsschrift 23 08 015.

Particularly preferred polyisocyanates are those having a molecular weight of less than 400 g/mol with NCO groups bonded to aliphatics or cycloaliphatics, such as, for example, 1,4-diisocyanatobutane, 1,6-diisocyanatohexane, 1,5-diisocyanato-2,2-dimethylpentane, 2,2,4- and 2,4,4-trimethyl-1,6-diisocyanatohexane, 1,3- and 1,4-diisocyanatohexane, 1-isocyanato-3,3,5-trimethyl-5-isocyanatomethylcyclohexane, 1-isocyanato-1-methyl-4-isocyanatomethylcyclohexane and 4,4′-diisocyanatodicyclohexylmethane, and any desired mixtures of such diisocyanates. Aliphatic polyisocyanates, such as the xylylene diisocyanates of the formulae 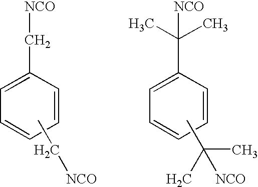
can also be used.

The above diisocyanates are preferably used. However, monofunctional aliphatic isocyanates, such as, for example, butyl isocyanate, hexyl isocyanate, cyclohexyl isocyanate, stearyl isocyanate or dodecyl isocyanate, and/or polyisocyanates having an average functionality of 2.2 to 4.2 can also be concomitantly used.

The polyisocyanates having a higher functionality are polyisocyanate mixtures which have isocyanurate groups consisting substantially of trimeric 1,6-diisocyanatohexane or 1-isocyanato-3,3,5-trimethyl-5-isocyanatomethylcyclohexane and optionally dimeric 1,6-diisocyanatohexane or 1-isocyanato-3,3,5-trimethyl-5-isocyanatomethylcyclohexane and the corresponding higher homologues and optionally uretdione groups and having an NCO content of 19 to 24% by weight, as are obtained by catalytic trimerization known per se and with isocyanate formation of 1,6-diisocyanatohexane or 1-isocyanato-3,3,5-trimethyl-5-isocyanatomethylcyclohexane and which preferably have an (average) NCO functionality of 3.2 to 4.2

Other suitable polyisocyanates A are polyisocyanates prepared by modifying aliphatic or cycloaliphatic diisocyanates and having uretdione and/or isocyanurate, urethane and/or allophanate, biuret or oxadizine structure, as are described by way of example, for example in DE-A 1 670 666, DE-A 3 700 209 and DE-A 3 900 053 and in EP-A 336 205 and EP-A 339 396. Suitable polyisocyanates are, for example, also the polyisocyanates containing ester groups, such as, for example, the tetrakis- or triisocyanates obtainable by reaction of pentaerythrityl- or trimethylolpropanesilyl ethers with isocyanatocaproyl chloride (cf. DE-A 3 743 782). In addition, it is also possible to use triisocyanates, such as, for example, triisocyanatodicyclohexylmethane.

The use of monofunctional and of more than difunctional isocyanates is limited in both cases preferably to amounts of not more than 10 mol % in each case, based on all polyisocyanates A.

However, the abovementioned aliphatic, cycloaliphatic and araliphatic diisocyanates are very particularly preferred.

Hexamethylene diisocyanate (HDI) is particularly preferred.

Suitable bisulphites and/or disulphites are preferably the alkali metal or ammonium salts thereof, in particular the sodium salt of sulphurous and disulphurous acid, i.e. sodium hydrogen sulphite (NaHSO₃) and sodium disulphite (Na₂S₂O₅), respectively.

The other alkali metal and ammonium salts of these acids can also advantageously be used, namely potassium bisulphite, potassium disulphite, lithium bisulphite, lithium disulphite, ammonium bisulphite, ammonium disulphite and simple tetraalkylammonium salts of these acids, such as, for example, tetramethylammonium bisulphite, tetraethylammonium bisulphite, etc. For blocking, the salts are preferably used as aqueous solutions having solids contents of 5 to 40% by weight.

The reaction of organic isocyanates with bisulphite/disulphite is preferably effected at 0 to 60° C., preferably 10 to 40° C., using aqueous solutions of alkali metal or ammonium sulphites in the presence of alcohol alkoxylate until all NCO groups have reacted. For this purpose, reaction times of 1 to 12, preferably 3 to 8, hours are generally required. The end products are optically clear aqueous solutions, in a few individual cases stable, finely divided emulsions having mean particle diameters of less than 800 nanometres.

Polyether alcohols which are obtainable in a manner known per se by alkoxylating suitable initiator molecules are suitable as preferred alcohol alkoxylates. For the preparation of the polyether alcohols, any desired monohydric or polyhydric alcohols having molecular weights of 88 to 438 can be used as initiator molecules.

They are particularly preferably alkoxylates of aliphatic alcohols having a chain length of 5 to 30 carbon atoms and 1-25 alkoxy units.

Preferably used are alcohol alkoxylates which are obtained by reacting at least one alcohol ROH with n moles of at least one alkylene oxide per mole of alcohol ROH,

in which

R is an alkyl radical having 5 to 30 carbon atoms which has a main chain having 4 to 29 carbon atoms which is branched in the middle of the chain with at least one C₁-C₁₀-alkyl radical;

the alkylene oxide has 2 to 6 carbon atoms

and

n has a value of 1 to 25.

In the context of the present invention, “middle of the chain” is to be understood as meaning those carbon atoms of the main chain, i.e. of the longest alkyl chain of the radical R, beginning with carbon atom C#2, the numbering starting from the carbon atom (C#1), which is bonded directly to the oxygen atom neighbouring the radical R, and ending with the carbon atom ω, which is the terminal carbon atom of the main chain, C#2 and the carbon atom ω-2 being included. This means that at least one of the carbon atoms C#2, C#3, . . . to C_{ω-2} of the main chain of the radical R is substituted by a C₁- to C₁₀-alkyl radical. Preferably, the carbon atom C#2 of the main chain of the radical R is substituted by a C₁- to C₁₀-alkyl radical. In addition, it is also possible for one or more carbon atoms in the middle of the chain to be substituted by two C₁- to C₁₀-alkyl radicals, i.e. for one or more carbon atoms in the middle of the chain to be quaternary carbon atoms.

Particularly preferred is a mixture of alcohol alkoxylates based on 1 to 3 different alcohols ROH, particularly preferably on 1 or 2 different alcohols ROH. The number of carbon atoms of the radical R may be different and/or the type of branching.

The main chain of the alcohols ROH preferably has 1 to 4 branches, provided that the chain length permits more than one branch in the middle of the chain, particularly preferably 1 to 3, very particularly preferably 2 or 3. These branches, independently of one another, generally have 1 to 10 carbon atoms, preferably 1 to 6, particularly preferably 1 to 3. Particularly preferred branches are accordingly methyl, ethyl, n-propyl or isopropyl groups.

The radical R of the alcohol ROH preferably has 5 to 30 carbon atoms. Since the radical R preferably has at least one branch with at least one carbon atom, the main chain comprises 4 to 29 carbon atoms. The radical R preferably has 6 to 25 carbon atoms, particularly preferably 10 to 20. This means that the main chain preferably has 5 to 24 carbon atoms, particularly preferably 9 to 19. Very particularly preferably, the main chain has 9 to 15 carbon atoms and the other carbon atoms of the radical R are distributed over one or more branches.

The alkylene oxide reacted with the branched alcohols ROH to give the alcohol alkoxylates used is preferably selected from the group consisting of ethylene oxide, propylene oxide and butylene oxide. It is also possible for a single alcohol ROH to be reacted with different members of said alkylene oxides, e.g. ethylene oxide and propylene oxide, it being possible to obtain alcohol alkoxylates which in each case have blocks comprising a plurality of units of an alkylene oxide, e.g. ethylene oxide, in addition to blocks comprising a plurality of units of a further alkylene oxide, e.g. propylene oxide. The alcohol alkoxylates used according -to the invention particularly preferably contain ethylene oxide (EO) units, i.e. the alkylene oxide used is preferably ethylene oxide.

Furthermore, in the reaction of a single alcohol ROH with different members of said alkylene oxides, e.g. ethylene oxide and propylene oxide, it is possible to obtain alcohol alkoxylates in which the various alkylene oxides are randomly incorporated. The amounts of alkylene oxide used are preferably 1 to 25 mol of alkylene oxide per mole of alcohol, preferably 1 to 20 mol particularly preferably 3 to 15 mol and very particularly preferably 5 to 12 mol. The composition according to the invention preferably contains
5 to 60% by weight, in particular 12 to 50% by weight, of the compound of the component a) containing carbamoylsulphonate groups and
0.1 to 30% by weight, in particular 0.5 to 25% by weight, of alcohol alkoxylate of the component b), based in each case on the composition.

Furthermore, the aqueous composition may contain further additives, preferably in an amount of up to 30% by weight.

The weight ratio of component a) to b) is preferably 1:1 to 99:1, in particular 5:1 to 35:1 .

Preferably, substances from the group consisting of the synthetic tanning agents, resin tanning agents, polymeric retanning agents, vegetable tanning agents, fatliquoring agents, buffers or fillers can be added as preferred additives in order thus to simplify the tanning process and to increase the quality of the leather.

The synthetic tanning agents suitable for this use are, for example, water-soluble condensates of sulphonated aromatics, formaldehyde and optionally further substances from the group consisting of the aromatics, urea or urea derivatives. Products based on the condensation of naphthalenesulphonic acids, ditolylethersulphonic acids, phenolsulphonic acids, dihydroxydiphenyl sulphone and phenol and combinations of these raw materials with formaldehyde and optionally urea or urea derivatives are preferred here.

Vegetable tanning agents are tanning agents obtained from vegetable sources and belonging to the classes consisting of the condensed tanning agents or hydrolysable tanning agents, e.g. chestnut extract, mimosa, tara or quebracho.

The polymeric retanning agents preferred for the application are high molecular weight water-soluble or water-dispersible products, for example from the (co)polymerization reaction of unsaturated acids and derivatives thereof, having, for example, a filling or fatliquoring effect on leather. (Co)polymerization products of acrylic and methacrylic acid and esters thereof are preferred.

Fatliquoring agents are substances based on biological, mineral or synthetic oils which can be provided with hydrophilic groups, for example by complete or partial sulphating, sulphiting, carboxylation or phosphating, for improving the usability in water.

Preferred fillers are inert organic salts and organic polymers, for example sulphates, such as sodium sulphate or potassium sulphate, talc, silicon oxide compounds, starch or ligninsulphonates.

The compositions according to the invention preferably have a pH of 3 to 7, preferably of 3.3-5.5. For this pH range, it is advantageous to adjust the composition to the suitable pH range by adding a buffering substance and to stabilize said composition. Suitable buffers for this purpose are preferably mixtures of weak acids and- bases and salts thereof. Mixtures containing monofunctional, bifunctional, polyfunctional or polymeric carboxylic acids and salts thereof are particularly preferred. Formic acid, acetic acid, oxalic acid, lactic acid, tartaric acid, maleic acid, glutaric acid, phthalic acid and/or adipic acid; trifunctional carboxylic acids, such as citric acid, or polymeric carboxylic acids, such as (co)polymerized products using (meth)acrylic acid, maleic acid or itaconic acid or derivatives thereof and the alkali metal, alkaline earth metal and/or ammonium salts of these compounds are suitable as examples thereof.

The aqueous compositions may be present, for example, as a solution or suspension. A solution is preferred.

In a preferred embodiment of the invention, the compounds containing carbamoyl groups are based on aliphatic isocyanates, such as hexamethylene diisocyanate, isophorone diisocyanate, dicyclohexyl diisocyanate and nonyl triisocyanate and mixtures thereof, but in particular hexamethylene diisocyanate. In particular 4 to 40, preferably 6 to 25, % of alcohol alkoxylate, based on the total amount of isocyanate, are used for the synthesis.

In a further preferred embodiment, the mixtures a)+b) are buffered with 0.5-20 g, preferably 1-10 g, of a mixture of one or more carboxylic acids and salts thereof per 100 ml.

In a further preferred embodiment, 5-30 g, preferably 10-25 g, of synthetic tanning agent are added to the buffered or unbuffered mixtures per 100 ml.

The invention furthermore relates to a process for the preparation of the aqueous compositions according to the invention, which is characterized in that the components a) and b) are mixed with water and optionally further additives, in particular in that isocyanate is introduced in the presence of component b) in water and reacted with bisulphites and/or disulphites, preferably until all isocyanate groups have reacted, and the mixture thus obtained and containing the components a) and b) is optionally mixed with water and further additives.

The reaction of the organic isocyanates with bisulphite/disulphite is preferably effected at 0 to 60° C., preferably at 10 to 40° C., using aqueous solutions of alkali metal or ammonium sulphites and alcohol alkoxylate, until all NCO groups have reacted. For this purpose, in general reaction times of 1 to 12, preferably 3 to 8, hours are required. The end products are as a rule optically clear aqueous solutions, in a few individual cases stable, finely divided emulsions having mean particle diameters of, preferably, less than 8000 nanometres.

The invention furthermore relates to the use of the compositions according to the invention as pretanning agents or tanning agents for hides and skins.

In the context of this invention, pretanning agent is understood as meaning a product by means of which a hide or a skin can be converted into a state which permits commercial mechanical treatments, such as samming or shaving, but further treatment steps with tanning substances are required for finishing the leather or fur.

The invention furthermore relates to a process for tanning hides and skins, which is characterized in that, after washing, liming, optionally unhairing and deliming, pretreated hides or skins are treated with the composition according to the invention.

The unhairing is of course dispensed with for the tanning of skins.

The appropriately prepared hides (referred to below as pelts) are preferably treated in aqueous liquor in a commercial tanning drum at a temperature of 10° C. -60° C. and a pH of 5-10, preferably 7-9.5, with 1-10%, preferably 2-6% (solid), of a mixture according to claim 1 in a manner such that a tanned intermediate having a shrinkage temperature of >70° C., preferably >74° C., is obtained. After addition of the product according to the invention, the product is preferably allowed to penetrate for preferably 0.25 to 8 h, preferably 0.5 to 2 h, and the product is preferably then fixed by adding a basifying agent. Suitable basifying agents are all known alkalis or mixtures thereof which are suitable in tanning, i.e., for example, alkali metal carbonates, bicarbonates, magnesium oxide, dolomite, tertiary amines, etc., but in particular dolomite and magnesium oxide. The fixing is preferably effected over a period of 2 to 24 h, preferably 4 to 12 h.

The tanned intermediates obtained are suitable for mechanical further processing by, for example, samming, shaving or splitting. Moreover, these intermediates are distinguished by a pronounced white, clear and lightfast natural colour, which is a substantial advantage compared with glutaraldehyde-tanned leathers. They can be retanned by commercial processes and finished to give soft and airy crust leathers.

The invention furthermore relates to a process for the production of leathers and furs, characterized in that prepared raw material is treated, in a liquor at a temperature of 10° C.-60° C. and a pH of 5-10, preferably 7-9, with 1-10%, preferably 2-6% (solid), of a mixture according to claim 1 in a manner such that the tanned intermediate having a shrinkage temperature of >70° C., preferably >74° C., is obtained.

In a special embodiment of the invention, the properties for mechanical further processing and the final leather properties can be further improved by adding further substances or tanning liquors to typical in tanning before, during or after the addition of the product according to the invention.

### EXAMPLES

A) Preparation of Compositions According to the Invention

A1: Comparative Example (Analogous to EP-A 0 690 135, Example 1)

150 g of methanol-initiated polyethylene oxide (MW 500) are heated under inert gas under reduced pressure at 120° C. until no more distillate (water) occurs. At 100° C., reaction is then effected with 1000 g of hexamethylene diisocyanate for 2 h under inert gas in the absence of water. After cooling to room temperature, the viscous material is stirred with cooling into 3500 g of 39% sodium hydrogen sulphite solution, and the mixture is adjusted to 40% solid with 1600 g of water and stirred for a further 24 h. A small amount of white solid is filtered off, and a clear, colourless solution having a pH of 5.3 is obtained.

A2: Reaction According to the Invention:

1000 g of hexamethylene diisocyanate are stirred into a solution of 150 g of polyether alcoholate (branched C₁₁ with 7 EO) in 5100 g of sodium bisulphite solution (26.5%) in the course of 30 min at room temperature, the reaction mixture warming up to about 40° C. Stirring is continued for 6 h at 20° C. A clear, 40% strength solution having a pH of 5.25 is obtained.

Further reactions which were carried out analogously to A2, in which clear solutions are likewise obtained, are shown in the table below.

| | | | Polyether | | | Reaction |
|---|---|---|---|---|---|---|
| | Isocyanate | | alcoholate | | Conc. | temp. |
| No. | Type | Amount | Type | Amount | (%) | (° C.) |
| A3 | HDI | 1000 | bC₈/6EO | 200 | 35 | 20 |
| A4 | HDI | 1000 | bC₁₂/8.5EO | 150 | 40 | 20 |
| A5 | HDI | 1000 | bC₁₃/10EO | 150 | 40 | 20 |
| A7 | HDI | 1000 | lC₁₂/9EO | 400 | 30 | 20 |
| A8 | HDI | 1000 | bC₁₂/8.5EO | 200 | 60 | 20 |
| A9 | HDI | 1000 | bC₁₃/10EO | 40 | 30 | 20 |
| A10 | HDI | 1000 | bC₁₃/10EO | 70 | 50 | 40 |
| A13 | IPDI | 1000 | bC₁₁/7EO | 200 | 35 | 30 |
| A14 | HDI/IPDI | 1000 | bC₁₁/7EO | 180 | 35 | 30 |
| A16 | MDI | 1000 | bC₁₃/10EO | 200 | 30 | 5 |
| A17 | HDI- | 1000 | bC₁₃/10EO | 200 | 40 | 30 |
| | Biuret | | | | | |
| A18 | HDI- | 1000 | bC₁₂/8.5EO | 170 | 40 | 20 |
| | Trimer | | | | | |
| A19 | HDI | 1000 | bC₁₁/9EO/PO | 180 | 40 | 20 |
| A20 | HDI | 1000 | bC₁₃/11EO/PO | 150 | 40 | 20 |

HDI = hexamethylene diisocyanate;
IPDI = isophorone diisocyanate;
TDI = toluidene diisocyanate;
MDI = methylenediphenyl diisocyanate;
stated amounts in g;
temperature data in ° C.;
concentration data in % solid;
b C₁₂ = branched alcohol having on average 12 C atoms, e.g. so-called Guerbet alcohols or Exxal types;
l C₁₀ = linear alcohol having on average 10 C atoms;
EO = ethylene oxide;
PO = propylene oxide.

For stabilization and improvement of the tanning properties, buffers and/or further substances were introduced by simple stirring at room temperature into the products thus obtained, and the concentration was, if required, adjusted by adding water. Some examples are shown in the table below.

| | Raw | | Amount | | Conc. | |
|---|---|---|---|---|---|---|
| No. | material | Additive | (g) | pH | (%) | Remark |
| A21 | A2 | Formate buffer | 40 | 3.5 | 44 | clear |
| | | | | | | solution |
| A22 | A4 | Lactate buffer | 30 | 4.0 | 43 | clear |
| | | | | | | solution |
| A23 | A8 | Citrate buffer | 15 | 5.0 | 59 | clear |
| | | | | | | solution |
| A24 | A5 | Citric acid | 6 | 3.5 | 40 | clear |
| | | | | | | solution |
| A25 | A3 | Polyacrylate | 50 | 4.5 | 30 | clear |
| | | | | | | solution |
| A26 | A9 | Polymethacrylate | 300 | 6.0 | 37 | clear |
| | | | | | | solution |
| A27 | A8 | Phosphate buffer | 23 | 6.8 | 40 | clear |
| | | | | | | solution |
| A28 | A20 | Sulphated fish | 200 | 5.3 | 50 | milky |
| | | oil | | | | solution |
| A29 | A2 | Lecithin | 170 | 5.6 | 48 | milky |
| | | | | | | solution |
| A30 | A19 | Naphthalene- | 400 | 5.5 | 50 | brown |
| | | sulphonate | | | | solution |
| A31 | A8 | Aromatic | 240 | 4.5 | 45 | brown |
| | | condensate I | | | | solution |
| A32 | A3 | Tara | 330 | 4.5 | 25 | colloidal |
| A33 | A5 | Citric acid + | 10/220 | 4.3 | 45 | brown |
| | | condensate II | | | | solution |
| A34 | A2 | Phosphate + | 15/120 | 6.2 | 42 | milky |
| | | sulphated | | | | solution |
| | | neatsfoot oil | | | | |

Amount of raw material = 1000 g;
stated amounts in g;
concentrations in % solid;
polyacrylic acid MW about 5000;
polymethacrylic acid Retan 540, product of Rohm and Haas Corp.;
aromatic condensate I based on ditolylethersulphonate, bishydroxyphenyl sulphone and formaldehyde, TANIGAN WLF, product of LANXESS Deutschland GmbH;
condensate II based on naphthalenesulphonate, bishydroxyphenyl sulphone and formaldehyde, TANIGAN BN, product of LANXESS Deutschland GmbH.

B) Tannings

Percentage data are based on the weight of the raw material/intermediates used.

B1: Medical Sheepskin, Chromium-Free

In a paddle customary in the industry, air-dried sheepskins are resoaked in 20 l of water per skin and 2.0 g/l of nonylphenol ethoxylate at 25° C. overnight and then fleshed. The skins thus prepared are degreased twice in aqueous liquor with 2.0 g/l of nonylphenol ethoxylate at 35° C. for 60 min in each case and thoroughly rinsed with warm water after discharge of the liquor. For preparation for tanning, fresh liquor is initially introduced, and 14-16 g/l of product A23 according to the invention are added at 25° C. without pickling. The pH is increased stepwise to 8.8 by adding magnesium oxide in three doses, and the temperature is then increased to 40° C. After a run time of 12 h, 7 g/l of sulphated synthetic fatliquoring agent and 2.0 g/l of lecithin-based dispersant are added to the same bath. After 2 h, the pH is reduced to 5.5 with formic acid. After discharge of the liquor, thorough rinsing is effected with cold water and the skins are finished in a commercially customary manner and have a shrinkage temperature of 77° C.

Compared with skins tanned in the commercially customary manner with glutardialdehyde, the skins according to the invention have a substantially lighter colour, both of leather and of wool, and better lightfastness. In the aldehyde test, DIN 53315 A, the measured values are substantially reduced compared with the prior art and are below the limit of detection of the method of 20 ppm.

B2: “Wet White” for Full-Grained Automotive and Furniture Leather, Model Process.

Salted cattle hides are washed, limed, unhaired, fleshed and split in the commercially customary manner. For deliming, 0.3% of sodium bisulphite, 2.5% of ammonium sulphate and 0.2% of fatty alcohol ethoxylate-based degreasing agent are added in 100% of liquor at 25° C. and agitated in a drum for 1 h. At pH 8.8, 1% of a bating enzyme is added, agitation is effected for a further 2 h and the liquor is then discharged.

In 50% of fresh liquor, 4% (solid) of the product A2 according to the invention are added to the pelt. After a penetration time of 2 h, the pH is increased to 9.0 by addition of 1.2% of magnesium oxide in 3 portions, and the leather is then agitated overnight at 40° C. For preparation for retanning, the pH is reduced to 5.0 with formic acid, 2.0% of naphthalenesulphonate is allowed to act for 1 h, the liquor is discharged and the wet white leather is sammed. The shrinkage temperature is measured and the leather is shaved.

Further experiments for assessing the quality of the tanning are carried out analogously. Some of the results are summarized in the table below.

| Product | Tg(° C.) | Handle | Sammability | Shavability |
|---|---|---|---|---|
| A1 (comparison) | 74 | slightly fatty | acceptable | acceptable |
| A2 | 76 | dry | good | good |
| A4 | 76 | dry | good | good |
| A5 | 75 | dry | good | good |
| A9 | 78 | dry | good | good |
| A24 | 76 | dry | good | good |
| A26 | 80 | dry, firmer | very good | very good |
| A33 | 78 | dry, firmer | very good | very good |

Tg = Shrinkage temperature in ° C.;
wet white: leather intermediate tanned without chromium and intended for mechanical treatment and further (re)tanning.

B3: Furniture Leather Tanned Without Chromium:

5.5% (solid) of the product A28 according to the invention are added, in 50% of liquor, to a pelt prepared in B2. After a penetration time of 2 h, the pH is increased to 8.8 by adding 2% of a mixture of magnesium oxide, sodium formate and calcium carbonate, and the leather is then agitated at 40° C. overnight. For preparation for retanning, the pH is reduced to 6.0 with formic acid, the liquor is discharged and the wet white leathers are sammed. The shrinkage temperature is measured (76° C.) and the leather is shaved to 0.9 mm thickness.

The shaved wet white leathers are treated at 30° C. in 100% of liquor for 30 min with 3% of naphthalenesulphonic acid condensate before 3% of sulphated fish oil and 3% of synthetic fatliquoring agent are added for preliminary fatliquoring. After a run time of 30 min, complete tanning is effected with 24% of a mixture of tara, mimosa and a synthetic tanning agent based on a naphthalenesulphonic acid/sulphone condensate in the course of 2 h and dyeing is effected with 3% of dye. After the liquor is made up with 100% of water at 45° C., a further 3% of sulphated fish oil and 2% of synthetic fatliquoring agent are added and fixing is effected the next morning by adding 1% of formic acid.

A top fatliquoring is carried out in fresh liquor (100%) at 45° C. with 7% of sulphated fish oil and 3% of synthetic fatliquoring agent, said top fatliquoring is fixed at 1% of formic acid and, after the liquor has been made with 200% of water, overdyeing is effected with 1% of dye. After fixing with 0.5% of formic acid, the liquor is discharged. washing is effected and the leather is finished in a commercially customary manner.

Very soft and nevertheless tight-grained, levelly dyed crust leathers having a very uniform milled grain which can be finished in an excellent manner are obtained.

1. An aqueous composition containing
a) at least one compound containing carbamoylsulphonate groups and
b) at least one alcohol alkoxylate.

2. The aqueous composition according to claim 1, wherein reaction products of organic isocyanates and bisulphite and/or disulphite are used as compounds of component a) which contain carbamoylsulphonate groups.

3. The aqueous composition according to claim 1, containing
5 to 60% by weight, of the compound of component a) containing carbamoylsulphonate groups and
0.1 to 30% by weight, of alcohol alkoxylate of component b), based in each case on the composition.

4. The aqueous composition according to claim 1, containing
12 to 50% by weight, of the compound of component a) containing carbamoylsulphonate groups and
0.5 to 25% by weight, of alcohol alkoxylate of component b), based in each case on the composition.

5. The aqueous composition according to claim 1, wherein reaction products of organic isocyanates and bisulphite and/or disulphite are used as compounds of component a) which contain carbamoylsulphonate groups and wherein the organic isocyanate is an isocyanate having a functionality of 1.8 to 3.5.

6. The aqueous composition according to claim 1, wherein reaction products of organic isocyanates and bisulphite and/or disulphite are used as compounds of component a) which contain carbamoylsulphonate groups and wherein the organic isocyanate is an isocyanate having a functionality of 1.8 to 3.5 and has a molecular weight of <800 g/mol.

7. The aqueous composition according to claim 1, wherein reaction products of organic isocyanates and bisulphite and/or disulphite are used as compounds of component a) which contain carbamoylsulphonate groups and wherein the organic isocyanate is an isocyanate having a functionality of 2 and a molecular weight of <400 g/mol.

8. The Aqueous composition according to claim 1, wherein reaction products of organic isocyanates and bisulphite and/or disulphite are used as compounds of component a) which contain carbamoylsulphonate groups and wherein the organic isocyanate is an aliphatic isocyanate in particular dicyclohexyl diisocyanate, isophorone diisocyanate, nonyl triisocyanate or hexamethylene diisocyanate, particularly preferably hexamethylene diisocyanate.

9. The Aqueous composition according to claim 1, wherein reaction products of organic isocyanates and bisulphite and/or disulphite are used as compounds of component a) which contain carbamoylsulphonate groups and wherein the organic isocyanate is an aliphatic isocyanate selected from the group consisting of dicyclohexyl diisocyanate, isophorone diisocyanate, nonyl triisocyanate and hexamethylene diisocyanate.

10. The aqueous composition according to claim 1, wherein the alkanol alkoxylate of component b) is the reaction product of at least one alcohol with n moles of at least one alkylene oxide and n denoting 3 - 25.

11. The aqueous composition according to claim 1, wherein the alkanol alkoxylate of component b) is the reaction product of at least one alcohol with n moles of at least one alkylene oxide, the alkylene oxide having 2-6 carbon atoms and n denoting 3-25.

12. The aqueous composition according to claim 1, wherein the alkanol alkoxylate of component b) is the reaction product of at least one alcohol with n moles of at least one alkylene oxide, the alkylene originating from the group consisting of ethylene oxide and propylene oxide and n denoting 3-25.

13. The aqueous composition according to claim 1, wherein the alkanol alkoxylate of component b) is the reaction product of at least one alcohol with n moles of at least one alkylene oxide and n denoting 3-25 and the alcohol is a compound having 5-30 carbon atoms.

14. The aqueous composition according to claim 1, wherein the alkanol alkoxylate of component b) is the reaction product of at least one alcohol with n moles of at least one alkylene oxide and n denoting 3-25 and the alcohol is a compound having a branched compound having 4-29 carbon atoms in the longest alkyl chain, and at least one C₁ to C₁₀ branch is in the C#2 to C#ω-2 region, C#1 representing the first and C#ω representing the last carbon atom of the longest chain.

15. The aqueous composition according to claim 1, wherein products from the groups consisting of the synthetic tanning agents, resin tanning agents, polymeric retanning agents, vegetable tanning agents, fatliquoring agents, fillers and/or buffer substances are contained as further additives.

16. The aqueous composition according to claim 1, wherein it contains buffers from the group consisting of the monofunctional, bifunctional, polyfunctional or polymeric carboxylic acids and salts thereof.

17. A Process for the preparation of an aqueous composition according to claim 1, wherein an aqueous solution of an alkanol alkoxylate and bisulphite and/or disulphite is reacted at a temperature of 0-70° C., with at least one organic isocyanate until free isocyanate can no longer be detected, and further additives are added or are not added.

18. A Process for the preparation of the aqueous compositions according to claim 1, wherein the components a) and b) are mixed with water and optionally further additives.

19. A Process for pretanning hides and skins wherein the aqueous compositions according to claim 1 is added to hides and skins.

20. A Process for tanning hides or skins, characterized in that hides or skins pretreated by washing, liming, optionally unhairing and deliming are treated with the aqueous composition according to claim 1.

21. Leathers and furs produced using a composition according to claim 1 as pretanning agent.

22. A process for the production of leathers and furs, wherein prepared raw material is treated, in aqueous liquor at a temperature of 10° C.-60° C. and a pH of 5-10, of a mixture according to claim 1 in a manner such that a tanned intermediate having a shrinkage temperature of >70° C., is obtained.
